(19) United States
(12) Patent Application Publication
(10) Pub. No.: US 2013/0058116 A1
(43) Pub. Date: Mar. 7, 2013

(54) Method and device for changing a light emission of at least one headlight of a vehicle

(71) Applicants: Roland GALBAS, Ludwigsburg (DE); Felix WULF, Ludwigsburg (DE)

(72) Inventors: Roland GALBAS, Ludwigsburg (DE); Felix WULF, Ludwigsburg (DE)

(21) Appl. No.: 13/591,395

(22) Filed: Aug. 22, 2012

(30) Foreign Application Priority Data
Aug. 23, 2011 (DE) 10 2011 081 382.9

(51) Int. Cl. B60Q 1/16

(52) U.S. Cl. 362/512

(57) ABSTRACT

A method for changing a light emission of at least one headlight of a vehicle. The method includes reading in a position signal which represents a position of the object in front of or alongside the vehicle. The method also includes changing the light emission from at least one headlight of the vehicle onto the object or into the surroundings of the object, using the position signal. For the change, a changing illumination pattern is emitted onto the object or into the surroundings of the object in order to change the light emission of the at least one headlight of the vehicle.

### RELATED APPLICATION INFORMATION

The present application claims priority to and the benefit of German patent application no. 10 2011 081 382.9, which was filed in Germany on Aug. 23, 2011, the disclosure of which is incorporated herein by reference.

### FIELD OF THE INVENTION

The present invention relates to a method for changing a light emission of at least one headlight of a vehicle, a corresponding device, and a corresponding computer program product.

### BACKGROUND INFORMATION

While driving in darkness, objects having a risk of collision are often perceived late in spite of being illuminated by headlights of the host vehicle or other light sources. Severe accidents are frequently the result, in particular when pedestrians or cyclists are involved.

Present roadway illumination systems in vehicles are characterized by flexible emission options, for example in order to not blind oncoming traffic and at the same time to provide optimal illumination of the roadway. In addition, such systems may already directly illuminate objects.

German patent document DE 10 2009 054 101 A1 discusses an illumination device for a vehicle, including at least one headlight which has a radiation source for generating infrared radiation and a light source for generating visible light. This radiation source is formed from multiple infrared light-emitting diode modules, each of which includes at least one infrared light-emitting diode. The light source is formed at least from a light-emitting diode module which includes at least one light-emitting diode, the radiation source being integrated into the light source.

### SUMMARY OF THE INVENTION

Against this background, with the aid of the present invention a method is presented for changing a light emission of at least one headlight of a vehicle, and also a device for warning a driver of a vehicle about an object present in the surroundings of the vehicle, and lastly, a corresponding computer program product, according to the main claims. Advantageous embodiments result from the respective subclaims and the following description.

The exemplary embodiments and/or exemplary methods of the present invention provide a method for changing a light emission of at least one headlight of a vehicle, the method having the following steps:
reading in a position signal which represents a position of the object in front of or alongside the vehicle; and
changing the light emission from the at least one headlight of the vehicle onto the object, using the position signal, whereby for the change, a changing illumination pattern is emitted onto the object or into the surroundings of the object in order to change the light emission of the at least one headlight of a vehicle.

Moreover, the exemplary embodiments and/or exemplary methods of the present invention provide a device which is designed to carry out or implement the steps of the method according to the present invention in appropriate units. In addition, as a result of this variant of the present invention in the form of a device, the object of the present invention may be achieved quickly and efficiently.

The present invention thus provides a device for changing a light emission of at least one headlight of a vehicle, the device having the following features:
an interface for reading in a position signal which represents a position of the object in front of or alongside the vehicle; and
a device for changing the light emission from the at least one headlight of the vehicle onto the object, using the position signal, whereby for the change, a changing illumination pattern is emitted onto the object or into the surroundings of the object in order to change the light emission of the at least one headlight of the vehicle.

In the present context, a device may be understood to mean an electrical device which processes sensor signals and outputs control signals as a function of same. The device may have an interface which may be provided by hardware and/or software. In a hardware design, the interfaces may be, for example, part of a so-called system ASIC which contains various functions of the device. However, it is also possible for the interfaces to be dedicated, integrated circuits or to be composed, at least partially, of discrete components. In a software design, the interfaces may be software modules which are present in addition to other software modules on a microcontroller, for example.

Also advantageous is a computer program product having program code which may be stored on a machine-readable carrier such as a semiconductor memory, a hard drive memory, or an optical memory and used for carrying out the method according to one of the above-described specific embodiments when the program is executed on a computer or a device.

The surroundings of the vehicle may be understood to mean an area of the vehicle on a roadway in front of the vehicle or abeam of and alongside the vehicle. An object may be understood to mean a mobile object such as another vehicle (“other vehicle”) or a pedestrian, for example, which moves autonomously in the time sequence. In addition, an immobile object, for example a traffic infrastructure device (such as a traffic sign or a reflector post) or a tree at the side of the roadway may also be understood as an object within the meaning of the present definition. Information or a signal which represents a position concerning the object may be understood as a position signal. For example, this information which is contained in the position signal may represent a distance, direction, size, or other information which denotes a geographical position of the object (which may be in relation to the vehicle) and/or a type of the object. A light emission may be understood to mean a radiation characteristic of a headlight. For example, in a first manner of a light emission, light may be emitted in high beam mode, whereas in a second manner of a light emission, light may be emitted in low beam mode. However, the light emission is not limited to the two mentioned modes; rather, an unlimited type and manner of the emission of light is understood to mean a “light emission.”

For example, curve lighting, highway lighting, or other light emission modes may be considered which fall under the designation of a “light emission” according to the above definition. This may involve individually adjustable modes which emit light onto the roadway in front of or alongside the vehicle or into the surroundings of the vehicle in order to achieve the most optimal illumination situation possible for a driver of the vehicle. The light emission is also carried out using the position signal, which means that the mode, or the area that is to be illuminated by the at least one headlight of the vehicle, is determined in such a way that the position signal is taken into account for computing or determining the exact configuration or defining the area to be illuminated in front of or alongside the vehicle. The surroundings of the object may be understood to mean an area that is present in the immediate proximity of the object, for example at a distance of one meter from the object. It may thus be ensured that not only is the object illuminated, but also the object itself is present in the area illuminated by the illumination pattern, so that the contours of the object may be better distinguished from the background than when only the object itself, and not the surroundings of the object, is/are illuminated. A changing illumination pattern may be understood to mean an illumination pattern that changes while being emitted.

For example, by changing the reflection properties or changing the direction of the light emission by the headlights, brighter and darker areas which appear to be moving are created which are directed, i.e., emitted, toward the recognized object. Thus, for an observer of the area which is struck by the illumination pattern, moving light structures appear which attract special attention of the observer, in particular the driver of the vehicle. The driver of the vehicle may be warned in this way.

The exemplary embodiments and/or exemplary methods of the present invention are based on the finding that the driver of a vehicle may be warned in a technically very simple manner by illuminating the object with a changing illumination pattern. In particular due to the headlights, being increasingly used in the future, which allow very flexible and rapid light emission, a significant increase in traffic safety by early warning of a driver may be achieved by emitting a moving illumination pattern. At the same time, another road user may be warned of the approaching vehicle, in the present case this road user being recognized as an object and illuminated with a changing illumination pattern. In addition, drivers of other vehicles having headlights which are not flexibly adjustable in this way may also benefit from the emission of the changing illumination pattern onto the object by the headlights of the vehicle, since the drivers of these other vehicles likewise may perceive the changing illumination pattern even though it has not been illuminated by the headlights of these other vehicles.

In this way, as a result of emitting the changing illumination pattern with the aid of the flexibly adjustable headlights of the vehicle, not only is the benefit to the driver of the vehicle which is appropriately equipped for the illumination with the changeable illumination pattern improved, but also the overall traffic safety is improved when this type of modern vehicle is present.

It is particularly advantageous when, in the step of the changing, an illumination pattern is emitted onto the object or into the surroundings of the object which has one subarea having a high brightness level and another subarea having a low brightness level, the subarea having the high brightness level moving toward the object. This type of specific embodiment of the present invention offers the advantage of good recognizability of the changing illumination pattern, since the “motion” of the brighter subarea has a high attention-getting effect. A brighter subarea may be understood to mean an area of the illumination pattern which has, for example, an at least 10% higher brightness level, which may be a 25% higher brightness level, than the subarea which is regarded as the subarea having the low brightness level.

To attract a particularly high level of attention from the observer, in particular the driver of the vehicle, in the step of the changing, the illumination pattern may be emitted in such a way that it has at least one area which is circular or which peripherally surrounds the object. A peripheral area is understood to mean an area which, similar to a circular shape, has neither a beginning nor an end. This type of specific embodiment of the present invention offers the advantage of a particularly good option for warning an observer, since, due to the high brightness level which appears around the object, the eye of the observer is usually focused on the midpoint or interior of this circular or peripheral shape in which the object is then present. By making use of the natural viewing direction while observing the surroundings, the attention of the observer is thus automatically focused on the object about which the observer is to be warned.

According to another specific embodiment of the present invention, in the step of the changing, the illumination pattern may be emitted in such a way that it has a linear strip-shaped area which in particular is emitted over the object in a moving manner while the light emission is being changed. A strip-shaped area may be understood to mean an area of the illumination pattern which approximately forms a segment of a straight line. This type of specific embodiment of the present invention offers the advantage that, as the result of using such a strip-shaped area of the illumination pattern which usually attracts a high level of attention from the observer due to its shape, notification concerning the object about which the observer, in particular the driver of the vehicle, is to be warned may be provided very quickly.

In order to transmit to the observer, in particular the driver of the vehicle, information concerning the magnitude of a hazard from the object or for the object, using the emitted illumination pattern, in the step of the reading in, the position signal may also include information concerning a type and/or a class of the object; in the step of the changing, one of at least two different illumination patterns is selected in response to the information concerning the type and/or the class of the object and emitted onto the object or into the surroundings of the object. Two different illumination patterns which have a different design, for example in at least 30 percent, advantageously in at least 50 percent, of the surface area of the illumination pattern may be used. For example, the illumination patterns may be distinguished by different colors or a different structure in these illumination patterns. It may thus be ensured that the observer, for example the driver of the vehicle, may very quickly draw conclusions concerning the hazard from the object or for the object based on the simple differentiation of the recognized illumination pattern, without having to recognize the object itself.

It is also advantageous when, in the step of the reading in, the position signal is read in which represents a position of a mobile object or a height of an object above a roadway. This type of specific embodiment of the present invention offers the advantage, on the one hand, of indicating in particular mobile objects which usually pose a greater hazard to the host vehicle (for example, when the object is another vehicle) or a greater hazard to the object (for example, when a pedestrian is involved), or on the other hand, of outputting an appropriate early warning that is easily understandable by the driver, in particular for areas on the roadway which are actually too low for the vehicle to travel through.

In particular during fast driving, for example on an expressway, it is advantageous if an object that represents a risk to the driving safety of the vehicle is recognized early, and the driver may thus be provided with early notification of this object. In this type of situation, it is advantageous when, in the step of the reading in, a driving signal concerning a vehicle parameter or a physical variable which represents a motion of the vehicle is also read in, in the step of the changing, the light emission also being carried out using the driving signal. Such a physical variable which represents a motion of the vehicle may be, for example, a yaw rate, an acceleration, or a similar Variable which is detected by a sensor in the vehicle, for example. A driving parameter may be understood to mean, for example, a setting of the vehicle or the position of a control element of the vehicle, such as a steering angle of the steering wheel, or a position or an angular position of a pedal, for example.

According to one particular specific embodiment of the present invention, in the step of the changing, a rate of a change of the illumination pattern emitted onto or alongside the object may be provided as a function of a read-in type or class of the object and/or a position of the object in front of or alongside the vehicle. This type of specific embodiment of the present invention offers the advantage of adaptability of the warning response without the risk of alarming the driver due to the suddenly emitted illumination pattern.

It is also advantageous if, according to another specific embodiment of the present invention, in the step of the reading in, traffic lane data are also read in which represent information concerning a relationship of the position of the object with respect to the traffic lane on which the vehicle is present, in the step of the changing, the light being emitted using the read-in traffic lane data. Traffic lane data may be understood to mean, for example, information which indicates whether the object is present on a traffic lane on which oncoming traffic is to be actually driving, or whether the object is present on the emergency lane or at the edge of the roadway. This information based on the traffic lane data may then be advantageously used for estimating the hazard from the object or to the object. For example, an object present on a traffic lane on which oncoming traffic is to be expected poses a greater expected risk for the host vehicle, since in this case an oncoming vehicle is probably involved. On the other hand, a lower risk for the host vehicle is assumed from an object on the emergency lane or at the edge of the roadway, since in this case the probability is higher that the object is a pedestrian, who is more endangered by the host vehicle than vice versa.

However, if it is presumed that the object is farther away than an extent of the emergency lane, a tree could be involved, from which once again a greater risk for the host vehicle is to be expected, for example if the driver loses control of the vehicle and collides with the tree. In this regard, this type of specific embodiment of the present invention offers the advantage of providing an appropriate illumination pattern which is output as a function of an actual hazard situation.

Furthermore, it is advantageous if, in the step of the reading in, information concerning a parking space that is present at an edge of a roadway traveled by the vehicle is read in, in the step of the changing, the light emission also being changed in such a way that at least a portion of the illumination pattern illuminates the parking space or is directed into the parking space. This type of specific embodiment of the present invention offers the advantage that in particular in darkness, when the search for a parking space is generally much more difficult, technical assistance in finding a suitable parking space is provided. The driver of the vehicle is thus provided with additional driving comfort by the flexible lighting unit, which is usually already implemented in the vehicle.

In addition, in another specific embodiment of the present invention, in the step of the reading in, a brightness signal may also be read in which represents a brightness level in the surroundings of the vehicle, in the step of the changing, the light emission being changed in response to the brightness signal, in particular in the step of the changing, the light emission being changed if the brightness signal indicates a brightness level that is below a predefined threshold. This type of specific embodiment offers the advantage that on the one hand, the emission of the illumination pattern may be made dependent on the surroundings brightness level, so that, for example, at dusk, at night of a full moon, or in the vicinity of illuminated streets, it is not necessary to use subareas having the high brightness levels such as for nights of the new moon or when traveling through a wooded area, and on the other hand, the emission of the illumination pattern is not switched on at all until a predefined brightness level is reached, since this type of warning in daylight does not function as desired.

Moreover, it is advantageous if, according to one particularly advantageous specific embodiment of the present invention, in the step of the reading in, information is read in that the vehicle is exiting from a parking space at that moment, in the step of the changing, the illumination pattern being emitted in such a way that at least one subarea of the illumination pattern is emitted onto an object, in particular another vehicle, that is abeam of the headlight. In this type of specific embodiment of the present invention, due to the emission of the illumination pattern cross traffic may advantageously be warned that the host vehicle is exiting from the parking space; the driver of the vehicle exiting from the parking space usually does not have an optimal overview of the cross traffic. In this specific embodiment of the present invention, the overall traffic situation with regard to a possible imminent collision of vehicles in cross traffic with the vehicle exiting from the parking space may thus be avoided when the vehicles in cross traffic are warned early by the emission of the illumination pattern.

The present invention is explained in greater detail below as an example, with reference to the appended drawings.

### BRIEF DESCRIPTION OF THE DRAWINGS

FIG. 1 shows a block diagram of a vehicle in which one exemplary embodiment of the present invention is used.

FIGS. 2A through 2C show schematic illustrations of examples of illumination diagrams which are usable in one exemplary embodiment of the present invention.

FIG. 3 shows a flow chart of one exemplary embodiment of the present invention.

FIG. 4 shows a schematic illustration of a vehicle approaching an obstacle situated at a certain height above the roadway.

FIG. 5 shows a diagram representing a risk of collision as a function of a position of the object from the middle of a traffic lane, the host vehicle traveling in the middle of the traffic lane.

FIG. 6 shows a schematic illustration of a scenario in which the approach presented herein may be used for finding a parking space.

FIG. 7 shows a schematic illustration of a scenario in which the approach presented herein is used for illuminating trees at an edge of the roadway which have been recognized as collision hazard objects.

FIG. 8 shows a schematic illustration of a scenario in which the approach presented herein is used for illuminating pedestrians at an edge of the roadway which have been recognized as collision hazard objects.

FIG. 9 shows a schematic illustration of a scenario in which the approach presented herein is used for illuminating cross traffic vehicles, which have been recognized as collision hazard objects, when exiting from a parking space.

### DETAILED DESCRIPTION

In the following description of exemplary embodiments of the present invention, identical or similar reference numerals are used for the elements having a similar action which are illustrated in the various figures, and a repeated description of these elements is dispensed with.

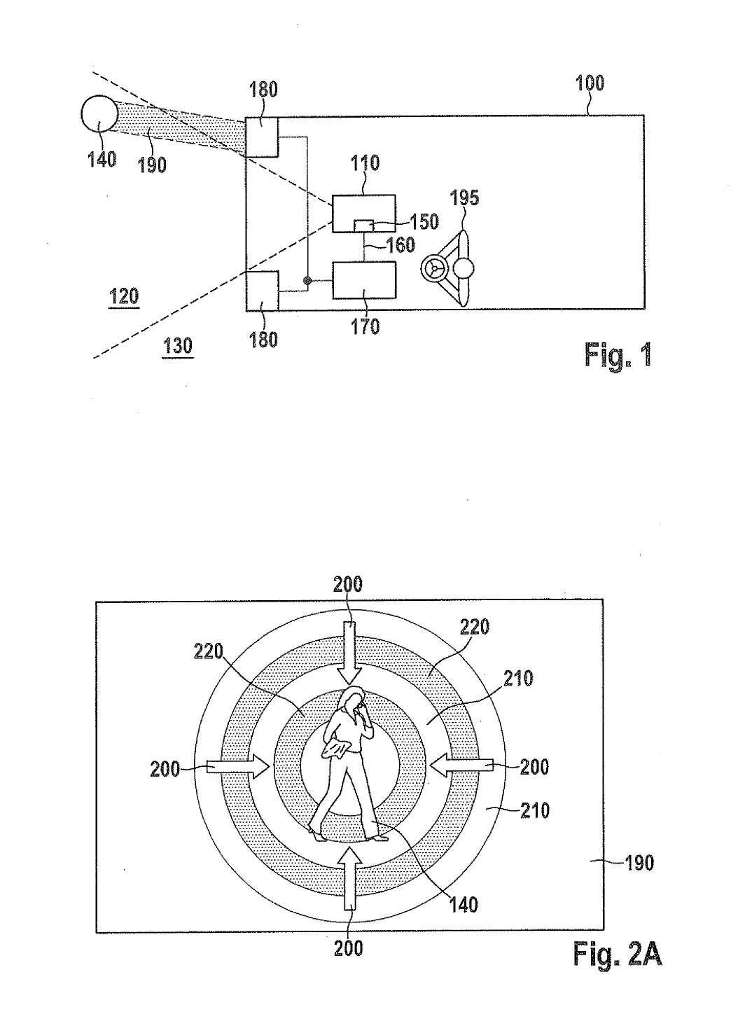

FIG. 1 shows a block diagram of a vehicle in which a first exemplary embodiment of the present invention is used. A vehicle 100 having a camera 110 is illustrated in FIG. 1. This camera 110 detects surroundings 130 of vehicle 100 in a viewing range 120. In detecting surroundings 130 of vehicle 100, camera 110 recognizes an object 140, positioned at the edge of the roadway, which represents a pedestrian or a tree, for example. This object 140 is classified in camera 110, for example in the “road user” class, in the present case, for example, in the “pedestrian” class, or in the “immobile object” class, in the present case, for example, in the “tree at the edge of the roadway” class.

In addition, in camera 110, which contains a small computer unit 150, for example, position information or a position signal 160 is determined which represents information concerning the position of object 140 and/or the type of object 140, or information concerning a position of object 140 in relation to a traffic lane on which vehicle 100 is traveling, or similar information, for example a risk assessment of the probability of a collision with object 140. This position signal 160 is transmitted to a unit 170 for changing the light emission from headlight 180 of vehicle 100. This transmission may take place, for example, by using data transmission structures which are already present in the vehicle, for example by using the CAN bus. Unit 170 may also be accommodated, for example, in a central light control system or some other central signal processing module. Unit 170 for changing the light emission then uses position signal 160 to ascertain a changing illumination pattern 190 which is emitted from at least one headlight 180 of vehicle 100 onto object 140 or into the surroundings of object 140, during emission of illumination pattern 190 an emission angle of different subareas of the pattern being changed differently with respect to object 140.

Due to the subareas now being illuminated using emission angles which change differently with respect to the object, areas of the illumination pattern result which appear to be moving upon striking the object or entering into the surroundings of the object. Due to the illumination pattern 190 which is output, it is thus possible to warn a driver 195 of vehicle 100 about object 140 by focusing the attention of driver 195 on the object as a result of changing illumination pattern 190.

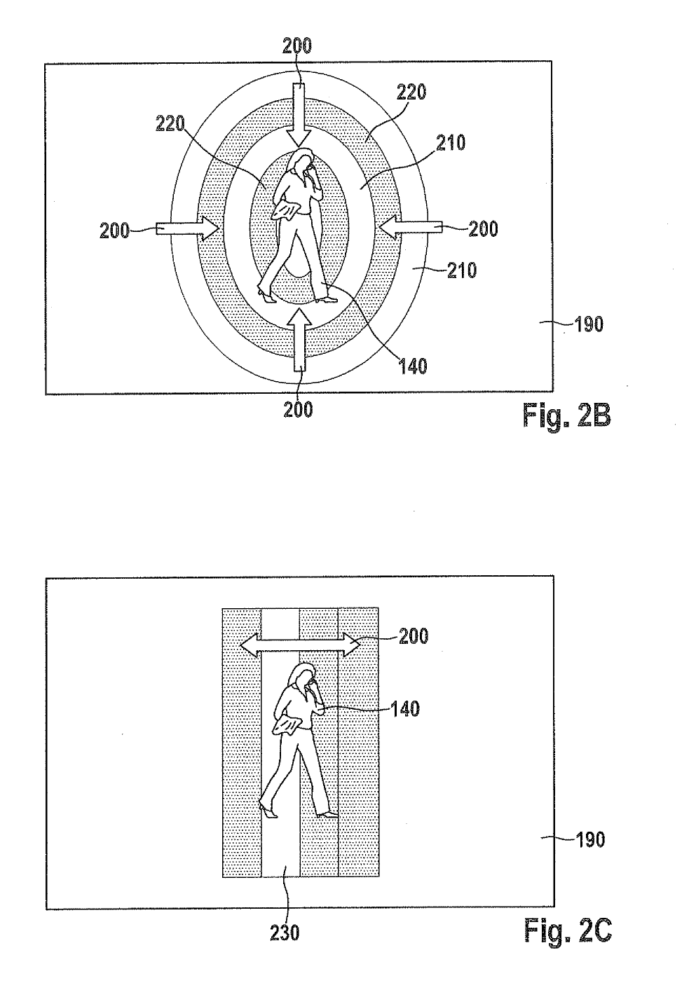

A simple illumination of objects for which there is a risk of collision is differentiated for the driver only slightly, with respect to other objects which are likewise illuminated, but only at lower intensity. It is an important aspect of the present invention that object(s) 140 in particular for which there is a high risk of collision are strongly differentiated or contrasted with respect to other objects for driver 195, by varying the light intensity/light intensity sequences on object 140 and in the surroundings of object 140, in order to focus the attention of driver 195 on the objects for which there is a risk of collision. The resulting option for differentiating for driver 195 the criticality of a collision via pattern diagrams/pattern sequences and via intensity differences is advantageous. For example, an object 140 that is recognized as a pedestrian is illuminated with one possible illumination pattern 190 (in particular an illumination pattern sequence) according to the illustration in FIG. 2A. Object 140 is illuminated with an illumination pattern 190 having circular light waves which travel toward object 140 (for which there is a risk of collision, for example) in the direction of arrows 200.

The light waves are formed by successive subareas 210 of illumination pattern 190 having a higher brightness level which alternate with subareas 220 of illumination pattern 190 having a lower brightness level. As a result of these apparently traveling light waves of subareas 210 having a higher brightness level, the attention of driver 195 is focused on object 140 for which there may possibly be an increased risk of collision. This motion, which may be understood as “pumping” of the illumination of object 140, thus ensures a very good warning about object 140.

In addition, it may also be provided for such “pumping” of the illumination of object 140 to be achieved by using an ellipse with light waves which travel toward the object for which there is a risk of collision 140, as illustrated in FIG. 2B. In contrast to the illustration in FIG. 2A, instead of circular subareas 210 having higher and lower brightness levels, a sequence of ellipsoidal subareas 210 having higher brightness levels and ellipsoidal subareas 220 having lower brightness levels is used. It likewise may be provided to use linear segments, for example alternating strips 230, of different brightness levels which are moved as illumination patterns 190 over object 140. These illumination patterns shown in FIGS. 2A, 2B, and 20 may also be used for objects 140 or types of objects 140 which are different in each case, of which the driver is to be warned. For example, a first type of object 140 may be irradiated with an illumination pattern 190 composed of circular subareas, whereas a second type of object may be irradiated with an illumination pattern 190 composed of ellipsoidal subareas or strip-shaped illumination patterns.

It is also advantageous if driver 195 of vehicle 100 learns the above-mentioned pattern diagrams or pattern sequences and intensity differences for various hazards, and thus develops quick reaction times to hazards. By using the approach presented herein, it is possible to differentiate objects via different light pattern sequences. Thus, a differentiation of illuminated objects based on headlight light patterns/headlight light pattern sequences in combination with light intensity differences is very helpful in warning a driver of the vehicle about an object which possibly represents a risk for a collision with the vehicle.

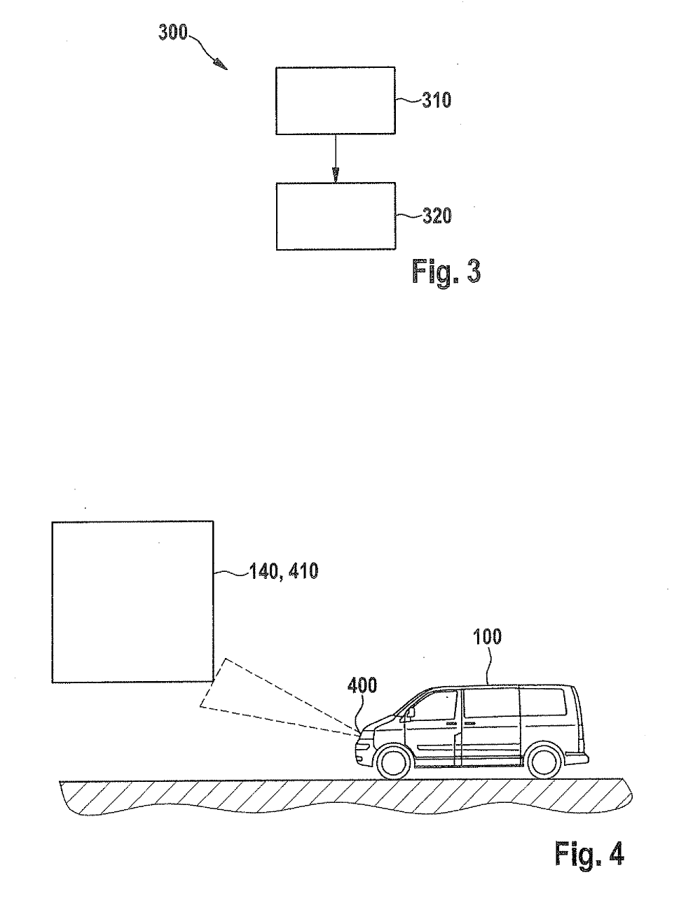

Moreover, the present invention provides a method 300 for changing a light emission of at least one headlight of a vehicle, as represented as an exemplary embodiment according to the flow chart in FIG. 3. Method 300 includes a step of reading in 310 a position signal which represents a position of the object in front of or alongside the vehicle. In addition, the method includes a step of changing 320 the light emission from the at least one headlight of the vehicle onto the object or into the surroundings of the object, using the position signal, whereby for the change, a changing illumination pattern is emitted onto the object or into the surroundings of the object in order to change the light emission of the at least one headlight of the vehicle.

Furthermore, an exemplary embodiment of the present invention may be provided in which the present invention is used as a method for informing, in particular warning, the driver by illuminating the hazard area with the driving lights when there is imminent risk of an accident due to driving into an area for which the vehicle is vertically or horizontally too small due to its dimensions. When driving into a vertically limited area, for example a parking garage, situations often occur in which vehicles having excessive height are involved in accidents. The circumstance of the vertical limitation for the vehicle being driven at that moment is often not perceived, for example due to switching to a van.

It also happens that lateral limitations are not perceived, thus resulting in damage (in a parking garage, for example). To avoid this type of damage, surroundings sensor systems such as video sensor systems or radar sensor systems, or also time of flight (TOF) systems such as PMD systems, are being increasingly used in vehicles.

At the same time, almost all vehicles have inertial sensor systems which are an integral part of an electronic stability program (ESP). Probabilities for a prospective driving corridor may be deduced on the basis of these systems. In addition, inertial sensor systems allow position predictions for the vehicle itself (pitch angle, roll angle).

Vehicle roadway lighting systems (headlights, for example) are increasingly being offered which have the capability for variable light positioning and variable light intensity setting (variable beam direction, for example).

The approach proposed herein now offers the option for warning the driver by illuminating the hazard area with the driving lights when there is imminent risk of an accident due to driving into an area for which the vehicle is vertically or horizontally too small due to its dimensions. According to one particular specific embodiment of the present invention, an active intervention (automatic braking, for example) may be carried out for recognizing such a risk or such an endangered or hazardous object which is to be irradiated with a changeable illumination pattern.

Furthermore, in another variant of this exemplary embodiment there is the option for outputting a warning or active intervention (braking, countersteering, for example), when there is imminent risk of an accident by continuing to drive along a route when the risk of a lateral collision is recognized.

The following procedure may be used in this exemplary embodiment.

### Step 1: Measurement

When driving into an area that is vertically or laterally limited, the surroundings sensor system measures the positions and surfaces of surrounding objects relative to vehicle positions. This is represented as an example in the schematic illustration in FIG. 4, in which a sensor system 400 in vehicle 100 measures the height of an obstacle 410 above the roadway, this obstacle 410 being recognized as object 140, for example by camera 110 from FIG. 1. The surrounding object properties and/or vehicle properties are now computed. This may be carried out according to the detailed steps described in greater detail below. Surroundings sensor system 400 initially measures or estimates the location, positions, and surface association of surrounding object 410 relative to the vehicle position. To assist in the measurement, for example image-processing video systems based on surface area estimations may estimate vehicle angular positions such as roll angle and pitch angle of the vehicle. In addition, radar systems, for example, may subsequently measure a direct distance from an object. For further assistance, inertial sensor systems inside the vehicle may estimate angular positions and in particular the angle with respect to the gravitational vector (pitch angle), as well as the roll angle. After the properties of the surrounding object have been computed and the vehicle properties have been measured or estimated, data preparation of the measured or estimated values is carried out.

This data preparation, for example based on data fusion of data of the surroundings sensor systems (video sensor systems, radar sensor systems, for example) together with the data of inertial sensor systems, may be used to increase the reliability of the measurement. The relative distance of surrounding objects or surfaces from the vehicle is obtained as the result, and a comparison with known vehicle dimensions provides an indication of possible endangerment of the object by the vehicle, or vice versa.

### Step 2: Risk Assessment

Based on the recognition of the driving direction and the speed (for example, based on data of the inertial sensor system of the ESP system) and optionally with data fusion using surroundings sensor systems, in conjunction with the measurement/estimation of the surrounding object properties, an accident probability may be estimated (for example, when driving into a parking garage that is too low for the vehicle or when driving into a parking space that is too narrow). The existence of an increased probability of an accident upon continued driving, and the particular exact position of the hazard area or the object, is obtained as the result.

### Step 3: Warning/Active Intervention

As a result of the knowledge about the hazard area (i.e., the position of the object) relative to the vehicle, the hazard area may now be directly illuminated and thus emphasized, based on the vehicle roadway lighting system (in particular the at least one headlight) having the capability for variable light positioning and variable light intensity setting (variable beam direction). In addition, the attention of the driver may be further increased by appropriate light pulse patterns on or toward the hazard area.

In addition, an active intervention into the control system of the vehicle may be initiated so that an imminent accident is automatically prevented by a driver assistance system of the vehicle.

In this type of exemplary embodiment it is advantageous that, for example by a parallel use of haptic (steering wheel vibration, braking jerk, etc.) and/or acoustic warning (a buzzer, for example), the warning which may be achieved by irradiating the object with an illumination pattern may be intensified.

In summary, it may thus be stated for this exemplary embodiment that a method is presented for measuring a risk of collision upon continued driving, based on vehicle dimensions and risk of lateral collision (SDF based on the surroundings sensor system and inertial sensor system). Variable light positioning or variable light intensity setting (i.e., a variable beam direction) may be used in the sense of a warning for directly emphasizing a cause of a hazard. In addition, the use of a light pulse pattern on or toward the hazard area increases the attention of the driver with respect to the cause of a hazard. Alternatively or additionally, to avoid the risk of collision an active intervention may be made into a vehicle control system (braking, steering, for example) when a collision risk described above is recognized.

Furthermore, according to another exemplary embodiment of the present invention, the approach proposed herein may be used in a method for reducing damage from an accident resulting from traffic lane departure. The motivation for this type of exemplary embodiment of the present invention is that inattentiveness or late recognition of the departure from a traffic lane may result in accidents. Collisions with stationary objects (for example, trees, guard rails, buildings, etc.) or moving objects (other road users, for example) may occur when a vehicle departs from its traffic lane. An important aspect of this exemplary embodiment of the present invention, therefore, is recognition of possible hazard situations and warning the driver of the host vehicle as well as other road users of this hazard situation.

Present systems are able to adapt the control of the vehicle lights based on data of the video sensor system. For example, U.S. 2007 0176080 A1 describes a system which with the aid of an imaging sensor and a logic and control circuit is able to adapt the beam of the low beam/high beam lights and adjust to the given traffic situation. Other systems warn other road users with the aid of light signals. For example, ZA 9408565 A describes a system for a warning device which emits warning signals on the basis of oncoming light. This system is intended for a stationary warning device such as a warning triangle, for example. In addition, the recognition of the oncoming traffic using only one brightness sensor is very susceptible to error. However, systems which control a headlight based on a previously predicted risk of collision in order to warn the driver and other road users are not known.

An objective of the exemplary embodiment of the present invention proposed herein is that hazards resulting from traffic lane departure are recognized, and the driver of the host vehicle and other road users are warned by adapting the headlight or the light emission from the headlight of the host vehicle.

The following steps may be used to achieve this objective.

### Step 1: Recognition of the Surroundings (Traffic Lane Scenarios)

A traffic lane of the host vehicle is predicted, and a perimeter/delimitation of the predicted traffic lane of the host vehicle is estimated based on subsequent data sources and appropriate sensor data fusion.

In general, additional traffic lane information is to be recognized using a surroundings sensor system for recognizing object information, whereby

A) stationary objects or markers (for example, parkway trees, guard rails, roadside structures, buildings, construction site barriers, etc.) and their reflections are recognized, for example with the aid of classical lane marker recognition via line recognition, for example using a video sensor system, radar sensor system, ultrasound, or the like, and/or

B) moving objects such as other road users, markers, and/or their reflections are recognized, for example using recognition of the headlights of oncoming traffic via video data, for example, or by evaluating traffic flow data of other road users, for example via C2X communication.

In general, recognition of additional traffic lane information via a surroundings sensor system or telemetric data transmission is also advantageous, it being possible to carry out map matching, for example, using a digital map and GPS information, based on which, among other things, roadway class information may be obtained. Additionally or alternatively, information concerning the probability of the number of traffic lanes per direction may be determined or read in. Furthermore, it may be provided for traffic lane information, for example available tunnel lanes and the direction of the tunnel, to be transmitted via C2X communication to an appropriately set-up unit in the vehicle. In addition, recognized traffic signs (for example, an expressway sign indicating multiple lanes in one direction, etc.) may be read in, for example with the aid of video.

The data which are read in or determined in some other way are then subjected to preprocessing, for example, in which data and/or information fusion and plausibility checking, for example, of the mentioned databases takes place. In addition, classification and plausibility checking of object data as well as increasing the probability of traffic lane data, for example by referencing stationary objects (such as a bridge, for example), may be carried out via GPS/map matching.

Information concerning the presence, position, and driving direction of all traffic lanes that are relevant for the host vehicle, and position(s) of objects and other road users (stationary and moving objects), may be obtained as the result of the prior data processing. In addition, data concerning the driving surroundings (for example, an expressway, highway, urban surroundings, etc.) and a probability of the correctness of the above data may be obtained.

Within the meaning of the motion of the host vehicle, a position and/or a sense of direction of the traffic lane on which the host vehicle is traveling and/or a position and/or a sense of direction of adjacent traffic lanes and their prospective spatial and temporal variation over time may be understood as a central reference variable for the further control of the light emission.

### Step 2: Prediction of the Probability of Traffic Lane Departure (Driving Maneuver Scenarios)

1) prediction of the prospective trajectory based on vehicle data pertaining to the host vehicle. ESP model computation or an ESP sensor system (for example, a detected steering wheel angle, wheel speeds, inertial sensor system, etc.), among others, may be used as the signal basis for computing the prospective trajectory. In addition, a turn signal and/or route data (from a navigation unit, for example), GPS map matching, for example by inputting the destination into a navigation unit or data from a driver observation (for example, by evaluation of the glance direction) may be used as the signal basis.

A probable occupancy of a spatial and temporal driving corridor of the host vehicle which represents, for example, a distribution of probabilities over possible travel trajectories of the host vehicle may be obtained as the result.

### Step 3: Plausibility Checking (I.e., a Comparison of the Ascertained Traffic Lane Scenarios to the Expected Driving Maneuver Scenarios)

In this third step, the probability of recognition of the traffic lane departure is increased by plausibility checking, as follows:

A) plausibility checking of the traffic lane scenarios from step 1 and of the driving maneuver scenarios from step 2. For example, if a probability for a recognized traffic lane is estimated to be 80%, i.e., the plausibility is checked with a value of 80%, a probability for a recognition of the traffic lane departure is recognized to be 60% or the plausibility is checked using such a value, and/or a probability for the assessment of the adjacent traffic lane as an oncoming traffic lane is recognized to be 20% or the plausibility is checked using this value.

B) Verification of the most relevant probabilities resulting from item A) above concerning changes in the driving maneuver data and driving scenario data to be expected.

For example, plausibility checking may be carried out by recognizing the oncoming traffic via radar data, for example (for example, recognizing that the oncoming traffic is moving into the trajectory of the host vehicle). Alternatively or additionally, plausibility checking of the oncoming traffic may be carried out by recognizing changes in surrounding objects via an evaluation of video data, for example by recognizing that guard rails/trees are moving into the trajectory of the host vehicle. The procedure from item B) represents a recursion; the scenarios created in the procedure according to item A) having the highest probabilities are verified by comparing the changes in the traffic lane scenarios and the changes in the driving maneuver scenarios to the result from the procedure from item A).

The probability of departure from the traffic lane of the host vehicle is obtained as the result.

### Step 4: Recognition of the Risk of Collision with Other Objects

The risk of collision is recognized using the data from steps 1 through 3 for recognizing and computing a risk of collision with

a) immobile objects (for example, guard rails, trees, buildings, roadside structures, etc.) and/or

b) mobile objects (for example, pedestrians, cyclists, automobiles, trucks, etc.).

The following aspects and/or values, for example, may be taken into account as the basis for recognizing the risk of a collision:
the probability of the presence of other (relevant) objects;
the probability of departure from the traffic lane of the host vehicle; and/or
the probability of the presence/the driving direction of the adjacent traffic lane.

The risk of collision with
immobile objects (for example, guard rails, trees, buildings, roadside structures, etc.) and/or
mobile objects (for example, pedestrians, cyclists, automobiles, trucks, etc.)
   is obtained as the result.

### Step 5: Control of at least One Headlight for Changing the Light Emission Characteristic in Response to the Recognized Risk of Collision

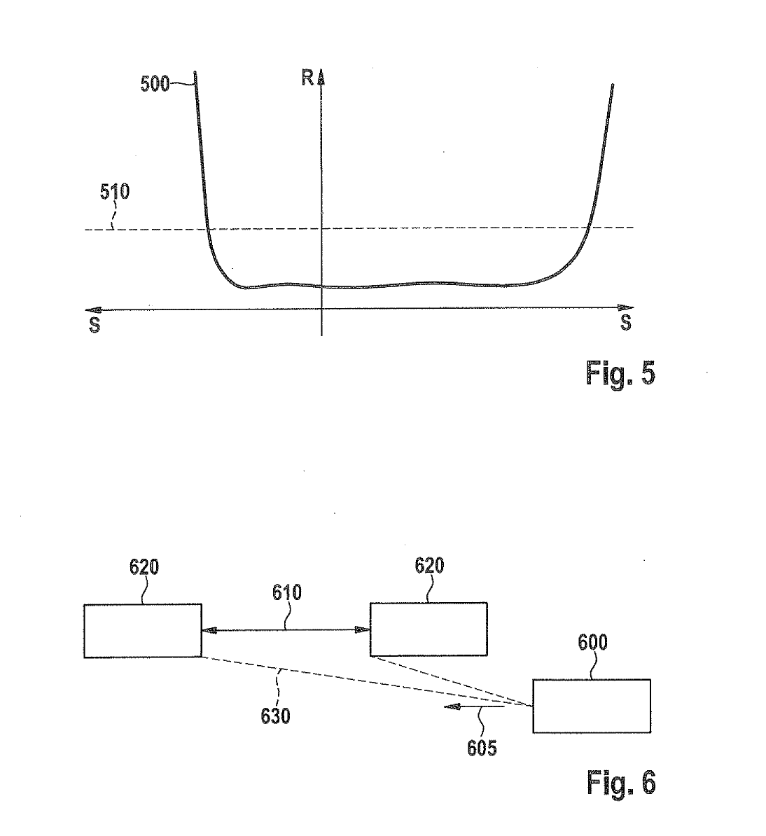

In general, it is to be noted that the headlights of the host vehicle should be controlled, in particular the high beam, according to the recognized risks when a predefined threshold value for the risk of collision is exceeded. This threshold value could be a function, for example, of the vehicle speed or the vehicle surroundings (expressway, highway, city, which has already been recognized in step 1). Such a control of the headlights for changing the light emission may be inferred from the diagram in FIG. 5, for example, in which distance s from the middle of the traffic lane on which the host vehicle is traveling is plotted on the abscissa, and risk of collision R is plotted on the ordinate. It is apparent that in areas situated at a great lateral distance (to the left as well as to the right) from the middle of the traffic lane, curve 500, which represents the risk of collision, indicates a sharp increase in the risk of collision which exceeds a risk of collision threshold value 510, so that the high beam should be used or the emission characteristic of the headlight(s) should be changed in these areas situated at a great distance from the middle of the traffic lane on which the host vehicle is traveling.

The objective of using the high beam according to this exemplary embodiment is in particular to output a warning or to focus the attention of the driver of the host vehicle or other road users. For immobile objects, such use of the high beam or a change in the light emission may be carried out in such a way that direct illumination of the object takes place in order to direct the attention of the driver of the host vehicle to the object which is endangered by a collision. For mobile objects, the high beam headlight may be activated or the emission characteristic may be changed in order to allow or implement a warning of the other road users of the recognized risk. In another aspect of the present invention, the use of the high beam or the change in the light emission could be limited to a certain period of time and/or be modulated at a certain frequency. In a further aspect of the present invention, it may be provided to overlap different (in particular two different) response patterns with mobile as well as immobile objects when the risk of collision is present.

According to another exemplary embodiment of the present invention, the above approach may also be used for implementing a method for assisting the driver in searching for parking spaces. The motivation for such a use is that drivers are usually not able to perceive potential parking spaces until very late. In particular, it is very difficult for the driver to rate whether a parking space is large enough, based on the length of the parking space, before the vehicle has passed the parking space. The driver is distracted by the search for a parking space, thus increasing the potential for a traffic accident in this situation. This effect is further intensified in darkness, since in this case it is even more difficult for the driver to recognize parking spaces early. Another problem with the known parking systems is that after driving past the parking space and after the recognition by the system, the driver must initially stop the vehicle. The distance between the vehicle which has come to a standstill and the parking space must not be so great that it is not possible for the automatic parking operation to still be carried out.

Today's parking systems measure parking spaces while the vehicle is driving by, with the aid of ultrasonic sensors mounted on the side of the vehicle. Thus, the recognition of whether a parking space is present may be made only after the vehicle has already passed the parking space. Such a system is described in DE 10 2005 032 096 A1 or DE 38 13 083 A1, for example. In the described systems, during the search for a parking space, in addition to the actual driving task the driver is also occupied with various tasks for monitoring the search for a parking space. In particular, after driving past a suitable parking space, the brakes must be applied until the vehicle comes to a standstill. Within the meaning of a rapid parking operation, it is meaningful and necessary for the distance between the parking space and the vehicle which has come to a standstill to not be too great. Therefore, one important aspect of this exemplary embodiment of the present invention is to assist the driver in the search for a parking space, in particular in darkness, and to provide the driver with early notification of possible parking spaces so that he is able to respond appropriately and also continue to concentrate on the actual driving task.

This exemplary embodiment thus allows early recognition of potential parking spaces. The potential parking space is marked with the aid of light beams from the headlight. This procedure for informing the driver of a sufficiently large parking space may be subdivided into multiple steps.

### Step 1: Recognition of the Intent to Park

The driver's intent to park the vehicle is identified in this step. For example, a signal which is generated by the driver by activating a parking button may be the basis for this type of identification. In addition, the intent to park may be identified from navigation data (for example, by very recently or already having reached the destination point) or from data from an interior camera (for example, data of a recognized viewing direction of the driver which may be classified as a “search” for parking spaces in the vicinity). In addition, a signal of a video sensor system, for example (for example, via a speed limit with the aid of traffic sign recognition, recognition of the traversable area in front of the vehicle, etc.), or a signal from a radar sensor system (for example, the presence of preceding vehicles) may indicate an intent of the driver of the host vehicle to park.

In addition, it may be provided for data of the host vehicle, such as the vehicle speed, for example, to also indicate an intent of the driver to park. Furthermore, a combination of the present data and possible plausibility checking of the above-mentioned signals may also indicate the intent to park, such as, for example, that the speed traveled is below the speed limit although no obstacle is recognizable ahead. A probability for a “driver intends to park” state may thus be obtained as the result of the recognition of the intent to park.

Step 2: Early Recognition of Potential Parking Spaces

Potential parking spaces may be recognized early by using the surroundings sensor system. It is not necessary to achieve 100% certainty that the recognized parking space is actually a parking space. Rather, the aim is only to provide an indicative system which indicates a parking space, which is measured and verified once more by an ultrasonic sensor system while driving by. For example, signals obtained from radar data (for example, reflections at the edge of the roadway at regular intervals indicate parked vehicles) and/or data from a video sensor system (for example, a classification of the surroundings data into parked vehicles, traveling vehicles, roadside structures, etc.) may be used as the basis for the early recognition of a potential parking space. Alternatively or additionally, data from map matching of GPS data (for example, a classification of the traversed road from a digital map indicates the presence of parking spaces at the edge of the road, for example, no parking spaces on expressways, highways, thruways, etc.) may be used as the basis for the early recognition of potential parking spaces.

Once these data are recorded, preprocessing of the data, for example fusion of the surroundings data may be carried out. For example, a recognition of potential parking spaces may be carried out on the basis of the data concerning the edge of the roadway, in particular “holes” between parked vehicles having a sufficiently large gap length also indicating a potential parking space. A recognition of the position of potential parking spaces and their probability of a sufficiently large parking space may be obtained as an objective of this step.

### Step 3: Processing of the Data and Control of the Headlight or Headlights

The processing of the data and the control of the headlight(s) may be based on the following conditions: an intent of the driver to park (“driver intends to park” state) may be initially recognized. A potential parking space may then be recognized, and it may also be recognized that the surroundings brightness level is low enough so that an emission of an illumination pattern also directs sufficient attention of the driver to the potential parking space. For example, if all conditions are met with sufficient accuracy, the headlight(s) is/are activated. In another aspect of the present invention, these limiting values for meeting the mentioned conditions could be a function of other data of the host vehicle (for example, a higher error tolerance is accepted at higher vehicle speed). The headlights of the vehicle are activated in such a way that they mark the position of the potential parking space with light beams. For example, this may be carried out corresponding to the illustration in FIG. 6, in which host vehicle 600, which is traveling in driving direction 605, detects a length of a parking space 610 between two vehicles 620 parked at the edge of the roadway, and directs light cone 630 of at least one headlight or a particular, in particular a changing, illumination pattern into this parking space. Thus, the driver of vehicle 600 does not have to independently take part in the search for the parking space, and may concentrate on the actual driving task. In another aspect of the present invention, the marking of the parking spaces could be limited to a certain period of time or be modulated at a certain frequency.

According to another exemplary embodiment of the present invention, the above approach may also be used for implementing a method for optimized warning of the driver in the event of departure from a traffic lane. An unintended departure from a traffic lane often results in hazardous situations or accidents. In present lane departure warning systems, informing or warning the driver of the risk of this driving situation is unsatisfactory, and is not transmitted in a timely manner. When the risk of departing a traffic lane is recognized, today's LDW systems typically inform or warn the driver via visual, haptic, or acoustic actuators (HMI) installed in the vehicle. However, the driver's attention is typically focused on the driving surroundings, not on the vehicle cockpit. In typical scenarios of unintentional lane departure, the visual attention of the driver is directed not to the traffic lane markers or roadside objects (trees, structures, etc.), but instead to other surroundings objects, for example passing vehicles. In addition, the driver is not able to directly associate the risk with the aid of present HMIs, since a specific association of the risk itself and with respect to the direction is often not provided. By the time the driver has cognitively comprehended and processed an orientation and association of the risk, the risk has often increased significantly or an accident has already occurred.

One particular aspect of the present invention is that with the aid of the approach described herein, it is advantageously possible to direct the visual attention of the driver onto the traffic lane and roadside objects which may result in risks/hazardous situations in the event of unintentional departure from the traffic lane. At the same time, the recognizability of roadside objects (distances, classification of the objects, estimation of the risks, etc.), and thus of the possible risks in darkness, is to be significantly improved. The application of the present invention may be used for dark surroundings.

This exemplary embodiment of the present invention may be implemented in multiple tasks or operations.

Step 1: Based on state-of-the-art technologies for recognizing the traffic lane departure (for example, video front radar or video rear radar, optional fusion of the surroundings data from various sensor systems or also use of GPS navigation (map matching)), the departure from a traffic lane is detected. The intention of the driver may be assessed and classified based on the driving behavior and the surroundings situation. Unintended traffic lane departure is recognizable.

An imminent departure from the traffic lane may be recognized, for example, based on the following signals:
signals of a surroundings sensor system
vehicle data of the host vehicle (for example, steering angle, steering speed, ESP sensor system, etc.)
driver observation (for example, via interior camera (viewing direction of the driver))
activation of the turn signal
other signals

### Step 2: Illumination of the Object

The system for illuminating selected objects may be activated when darkness is recognized or when the headlights are switched on. Darkness may be recognized, for example with the aid of brightness sensors, video sensor systems, C2X communication, or the like. On the basis of the unintended traffic lane departure recognized in step 1, the following action patterns, for example, are activated:

1. increasing the brightness level of the headlights on the side of the increased risk

2. illuminating/emphasizing the traffic lane marker in the driving direction of the traffic lane departure

3. illuminating/emphasizing objects having a risk of collision (for example, recognized by radar, video, etc.) possibly present in the driving direction of the traffic lane departure.

An illumination/emphasis of the objects may be intensified by varying pulsation patterns of the illumination using different frequency modulation. One important aspect of this exemplary embodiment is to focus the driver's attention directly on the objects or markers (traffic lane markers, roadside objects, trees, pedestrians, etc.) causing the risk. An increase in attention is already achieved by the vehicle's autonomous changing of the headlight cone.

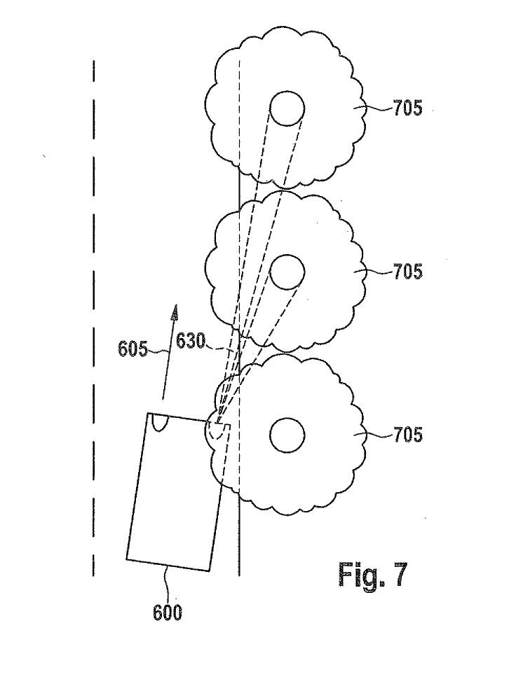

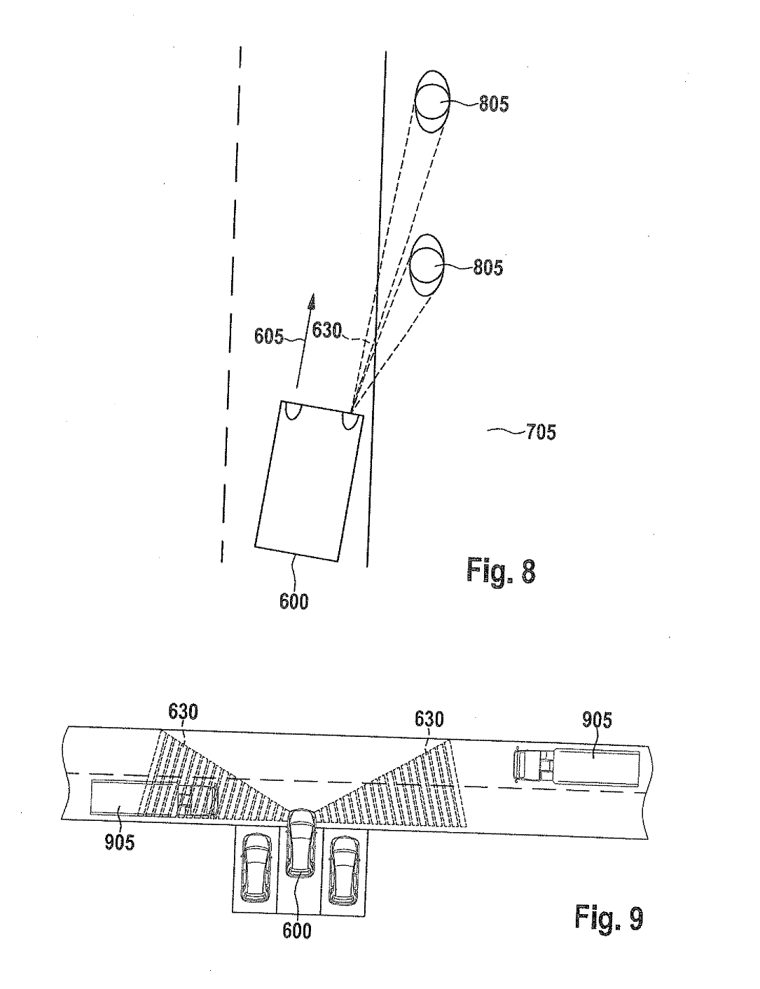

For example, immobile objects such as trees may be illuminated corresponding to the illustration in FIG. 7. Trees 705 are situated at the edge of the roadway and are illuminated by a changing light pattern from light cone 630 from at least one headlight of vehicle 600. Similarly, mobile objects such as pedestrians 805, for example, may be illuminated, as represented in the schematic illustration in FIG. 8.

According to another exemplary embodiment of the present invention, the above approach may also be used for implementing a method for warning other road users during exiting from parking spaces or when driving into a cross traffic situation. The motivation for implementing this type of exemplary embodiment may be seen in that when exiting from parking spaces, the driver frequently lacks an overview of the traffic situation into which he is driving. Accidents with cross traffic are often the consequence. In addition, severe accidents are sometimes dependent on the speed of the cross traffic. In general, accidents with cross traffic are extremely hazardous, and have high mortality rates.

Today's vehicle roadway lighting systems (i.e., in particular headlights) are able to emit the emitted light in variable directions, also laterally. In addition, based on a surroundings sensor system and vehicle sensor system as well as GPS in combination with a digital map or also C2X communication, it is possible to recognize that a vehicle is exiting from a parking space or is driving into a cross traffic situation.

The approach according to the present invention presented above may be used in particular to ensure that when exiting from a parking space and driving into a cross traffic situation, the light cones of the headlights which otherwise radiate in the driving direction are, for example,
A) automatically switched on and/or
B) laterally (to the right and left) externally positioned or directed and/or
C) automatically reduced, for example after reaching a minimum speed and/or based on some other sensor information. This sensor information may be collected inside the vehicle, for example, and, for example, may detect the steering behavior via a steering angle sensor, and/or may be collected outside the vehicle, for example using a video sensor system, a GPS system in combination with a digital map, or based on an ultrasonic sensor system. A changing illumination pattern may be output by the headlights of the host vehicle. The attention of the drivers in the cross traffic may thus be directed to the vehicle exiting from a parking space/entering cross traffic, or so that in particular crossing road users may be warned.

It is particularly advantageous if a dedicated special light pattern sequence is emitted (for exiting from a parking space), for example light is emitted from top to bottom, so that crossing road users are not blinded but are still informed/warned by the movement of light. Such an illumination pattern may be emitted, for example, according to the illustration in FIG. 9. Cross traffic, in particular drivers of crossing vehicles 905, are thus warned by the (in particular changing) illumination pattern in light cone 630 which is emitted from host vehicle 600 which is exiting from a parking space.

The light cone may be guided similarly as for a calming hand motion (in a placating manner, for example when the palms of the hands are pressed and slowly dropped downwardly and/or quickly moved upwardly, such as when calming crowds of people). After the situation of vehicle 600 exiting from the parking space is recognized, the light emission by the headlight(s) is once again positioned in the driving direction of host vehicle 600.

In particular, a situation of driving into cross traffic is to be taken into account in this exemplary embodiment. The exiting from a parking space is initially recognized in host vehicle 600. The recognition of exiting from a parking space into a cross traffic situation may be represented by ultrasound, for example, and/or by signals of a video sensor system, for example. Lateral ultrasonic sensors (USS) recognize the change of lateral objects to an unobstructed view. A video sensor system installed in the front direction recognizes, for example, the cross roadway situation and vehicles which may be crossing (which increase the probability of recognizing the situation). In addition, when driving into the parking space the situation may likewise be recognized and stored by an ultrasonic sensor or a video sensor system (for example, in the EEPROM of a control unit). Based on additional sensors such as a GPS system in combination with a digital map, signals of a backup camera, etc., a sensor data fusion may be represented which allows the situation of exiting from a parking space into a cross traffic situation to be recognized with high probability. In addition, vehicle-to-vehicle or infrastructure-to-vehicle communication (also referred to as C2XC) may be used to increase the probability. Information may also be transmitted. The swiveled light cone of the vehicle, in addition to the transmitted information via C2XC “a vehicle driving into cross traffic,” may also provide a very pleasing visual complement. Furthermore, lateral light systems (turn signals) may also be used for information, for example with the aid of high-frequency pulses. The recognition of the situation and general application of the function may be made dependent on other vehicle data such as the measured vehicle speed, for example.

Another option for using the present invention in this exemplary embodiment may represent recognition of a situation of driving into cross traffic, for example at an intersection. The entry of the vehicle into an intersection (for example, an approach) is initially recognized. This recognition function, which is used when exiting from a parking space, may thus be used, for example, when approaching intersections. The recognition of the situation could be adapted, for example, by recognizing traffic signs, signal devices (traffic lights, for example), and of course also once again on the basis of data of a GPS system in combination with a digital map or C2XC.

The latter exemplary embodiment presented thus relates in particular to a recognition of the “driving into cross traffic” situation and a subsequent departure from this situation. In addition, crossing road users are informed and/or warned on the basis of light pattern sequences aimed at the lateral traffic by a vehicle roadway lighting system of the host vehicle.

The exemplary embodiments which are described and shown in the figures are selected only as examples. Different exemplary embodiments may be combined with one another in their entirety, or with respect to individual features. In addition, one exemplary embodiment may be supplemented with features of another exemplary embodiment.

Furthermore, method tasks or operations according to the present invention may be repeated and carried out in a sequence other than that described.

If an exemplary embodiment includes an “and/or” conjunction between a first feature and a second feature, this may be construed in such a way that according to one specific embodiment, the exemplary embodiment has the first feature as well as the second feature, and according to another specific embodiment, the exemplary embodiment either has only the first feature or only the second feature.

What is claimed is:

1. A method for changing a light emission of at least one headlight of a vehicle, the method comprising:
reading in a position signal which represents a position of the object in front of or alongside the vehicle; and
changing the light emission from the at least one headlight of the vehicle onto the object or into the surroundings of the object, using the position signal, so that for the change, a changing illumination pattern is emitted onto the object or into the surroundings of the object to change the light emission of the at least one headlight of the vehicle.

2. The method of claim 1, wherein in the changing operation, an illumination pattern is emitted onto the object or into the surroundings of the object which has one subarea having a high brightness level and another subarea having a low brightness level, the subarea having the high brightness level moving toward the object.

3. The method of claim 1, wherein in the changing operation, the illumination pattern is emitted so that it has at least one area which is circular or which peripherally surrounds the object.

4. The method of claim 1, wherein in the changing operation, the illumination pattern is emitted so that it has a linear strip-shaped area, which in particular is emitted over the object in a moving manner while the light emission is being changed.

5. The method of claim 1, wherein in the reading in operation, the position signal also includes information concerning a type or a class of the object, in the changing operation, one of at least two different illumination patterns also being selected in response to the information concerning the type or the class of the object and emitted onto the object or into the surroundings of the object.

6. The method of claim 1, wherein in the reading in operation, the position signal is read in which represents a position of a mobile object or a height of a nonmobile object above a roadway.

7. The method of claim 1, wherein in the reading in operation, a driving signal concerning a vehicle parameter or a physical variable which represents a motion of the vehicle is also read in, in the changing operation, the light emission also being performed using the driving signal.

8. The method of claim 1, wherein in the changing operation, a rate of a change of the illumination pattern emitted onto the object or alongside the object takes place as a function of a read-in type or class of the object and/or a position of the object in front of or alongside the vehicle.

9. The method of claim 1, wherein in the reading in operation, traffic lane data are also read in which represent information concerning a relationship of the position of the object with respect to the traffic lane on which the vehicle is present, in the changing operation, the light being emitted using the read-in traffic lane data.

10. The method of claim 1, wherein in the reading in operation, information concerning a parking space that is present at an edge of a roadway traversed by the vehicle is read in, in the changing operation, the light emission also being changed so that at least a portion of the illumination pattern illuminates the parking space or is directed into the parking space.

11. The method of claim 1, wherein in the reading in operation, a brightness signal is read in which represents a brightness level in the surroundings of the vehicle, in the changing operation, the light emission being changed in response to the brightness signal, in particular in the changing operation, the light emission being changed if the brightness signal indicates a brightness level that is below a predefined threshold.

12. The method of claim 1, wherein in the reading in operation, information is read in that the vehicle is exiting from a parking space at that moment, in the changing operation, the illumination pattern being emitted so that at least one subarea of the illumination pattern is emitted onto an object, in particular another vehicle, that is abeam of the headlight.

13. A device for changing a light emission of at least one headlight of a vehicle, comprising:
an interface for reading in a position signal which represents a position of the object in front of or alongside the vehicle; and
a changing device for changing the light emission from the at least one headlight of the vehicle onto the object, using the position signal, so that for the change, a changing illumination pattern is emitted onto the object or into the surroundings of the object to change the light emission of the at least one headlight of the vehicle.

14. A computer readable medium having a computer program, which is executable by a processor, comprising:
a program code arrangement having program code for changing a light emission of at least one headlight of a vehicle, by performing the following:
reading in a position signal which represents a position of the object in front of or alongside the vehicle; and
changing the light emission from the at least one headlight of the vehicle onto the object or into the surroundings of the object, using the position signal, so that for the change, a changing illumination pattern is emitted onto the object or into the surroundings of the object to change the light emission of the at least one headlight of the vehicle.
